(19) United States
(12) Patent Application Publication
(10) Pub. No.: US 2009/0058518 A1
(43) Pub. Date: Mar. 5, 2009

(54) HIGH-PASS FILTER

(75) Inventors: Hideo Imaizumi, Ota-shi (JP); Tomoki Shioda, Ora-gun (JP)

Correspondence Address: OSHA LIANG L.L.P., TWO HOUSTON CENTER, 909 FANNIN, SUITE 3500, HOUSTON, TX, 77010, US

(73) Assignees: SANYO ELECTRIC CO., LTD., Osaka (JP); SANYO SEMICONDUCTOR CO., LTD., Ora-gun (JP)

(21) Appl. No.: 12/196,077

(22) Filed: Aug. 21, 2008

(30) Foreign Application Priority Data
Aug. 27, 2007 (JP) 2007-219257

(51) Int. Cl. H04B 1/10

(52) U.S. Cl. 327/559

(57) ABSTRACT

A capacitor has one end receiving an input signal and the other end outputting an output signal. A resistor circuit, connected between a power source and the other end of the capacitor, functions as a resistor. The resistor circuit includes a PNP transistor having a base connected to the other end of the capacitor and an NPN transistor having a base connected to the other end of the capacitor. A differential amplifier supplies complementary current to the PNP transistor and the NPN transistor. The differential amplifier receives, as negative feedback, the output signal from the other end of the differential amplifier.

### PRIORITY INFORMATION

This application claims priority to Japanese Patent Application No. 2007-219257, filed on Aug. 27, 2007, which is incorporated herein by reference in its entirety.

### BACKGROUND OF THE INVENTION

1. Field of the Invention

The present invention relates to a high-pass filter including a capacitor and a resistor circuit.

2. Description of the Related Art

A coupling capacitor (DC-cut capacitor) is generally usable to connect two or more circuits having different direct-current (DC) levels. A coupling capacitor applicable to an audio band (20 Hz to 20 kHz), which is in a relatively low frequency region, has a large capacitance. Installing a coupling capacitor having such a large capacitance on a semiconductor integrated circuit is difficult. Therefore, as discussed in Japanese Patent application Laid-Open No. hei7-321560, a coupling capacitor is installable as an external capacitor.

There is a demand for a semiconductor integrated circuit having the smallest number of external components. Furthermore, to realize a high-pass filter having a lower cut-off frequency, it is necessary to increase a capacitance value of the capacitor or a resistance value of the resistor.

### SUMMARY OF THE INVENTION

According to an aspect of the present invention, a high-pass filter includes a capacitor having one end receiving an input signal and the other end outputting an output signal, and a resistor circuit connected between a power source and the other end of the capacitor. The resistor circuit includes a PNP transistor having a base connected to the other end of the capacitor, an NPN transistor having a base connected to the other end of the capacitor, and a differential amplifier supplying complementary current to the PNP transistor and the NPN transistor. The differential amplifier receives, as negative feedback, the output signal from the other end of the differential amplifier.

The resistor circuit generates an output corresponding to a difference in base current between the PNP transistor and the NPN transistor. Therefore, the resistor circuit can operate as a resistor circuit having a large resistance.

### BRIEF DESCRIPTION OF THE DRAWING

A preferred embodiment of the present invention will be described in detail based on the following figure, wherein

FIG. 1 illustrates a circuit arrangement of a high-pass filter according to an embodiment.

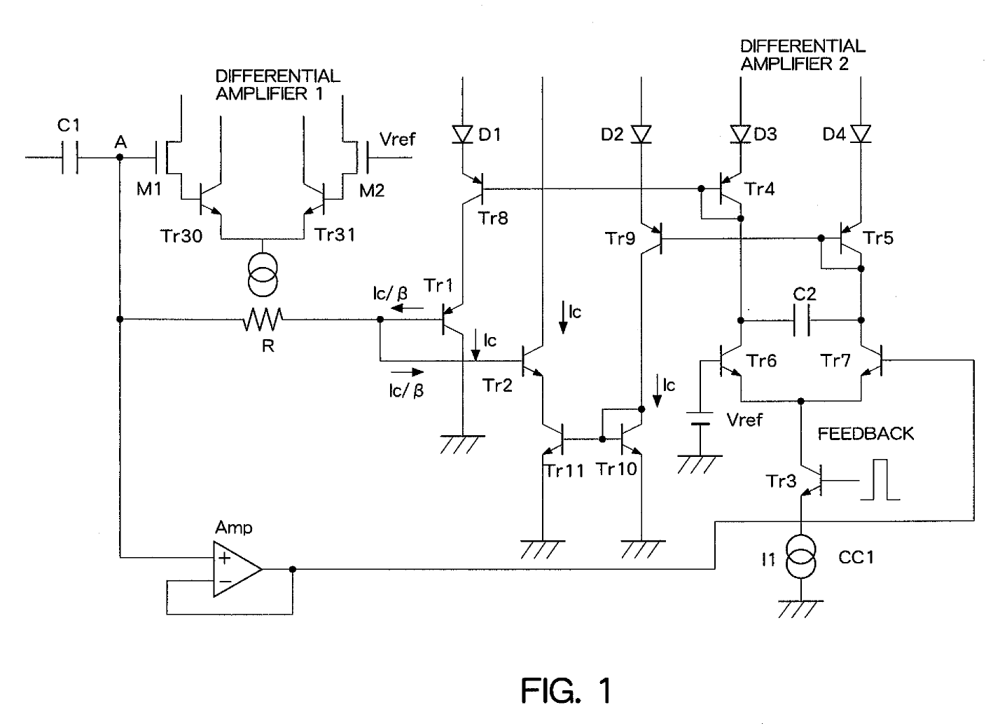

### DESCRIPTION OF PREFERRED EMBODIMENT

An embodiment of the present invention is described below with reference to the drawing.

A coupling capacitor C1 has one end receiving an input audio signal and the other end connected to a gate of an N-type Metal Oxide Semiconductor (MOS) transistor M1. The N-type MOS transistor M1 and another N-type MOS transistor M2 cooperatively constitute a differential amplifier 1. The N-type MOS transistor M2 has a gate connected to a reference voltage terminal that maintains an electrical potential of Vref. The MOS transistor M1 has a source connected to a base of an NPN transistor Tr30. The MOS transistor M2 has a source connected to a base of an NPN transistor Tr31. The transistors Tr30 and Tr31 have emitters commonly connected to a constant current source.

Accordingly, in the amplifier 1, currents flowing through the transistors Tr30 and Tr31 are variable according to an input signal. The amplifier 1 can generate an output from collectors of the transistor Tr30 or Tr31. Accordingly, the differential amplifier 1 receives an audio signal and outputs an amplified audio signal. The differential amplifier 1 has an ordinary arrangement for amplification, although not illustrated in detail.

A PNP transistor Tr1 has a base connected, via a resistor R, to the other end of the coupling capacitor C1. An NPN transistor Tr2 has a base connected, via the resistor R, to the other end of the coupling capacitor C1. The transistor Tr1 has a collector connected to the ground and an emitter connected to a collector of a PNP transistor Tr8. The transistor Tr8 has an emitter connected to the power source via a diode D1.

The transistor Tr2 has a collector connected to the power source and an emitter connected to a collector of an NPN transistor Tr11. The transistor Tr11 has an emitter connected to the ground. The transistor Tr11 has a base connected to a base of an NPN transistor Tr10. The transistor Tr10 has an emitter connected to the ground and a collector directly connected to the base. In other words, the transistor Tr10 has collector and base terminals that are short-circuited. Accordingly, two transistors Tr10 and Tr11 cooperatively constitute a current mirror circuit.

A PNP transistor Tr9 has a collector connected to the collector of the transistor Tr10. The transistor Tr9 has an emitter connected, via a diode D2, to the power source.

The transistor Tr8 has a base connected to a base of a PNP transistor Tr4. The transistor Tr4 has an emitter connected, via a diode D3, to the power source. The transistor Tr4 has a collector directly connected to the base. In other words, base and collector terminals of the transistor Tr4 are short-circuited. Accordingly, two transistors Tr4 and Tr8 cooperatively constitute a current mirror circuit. The transistor Tr9 has a base connected to a base of a PNP transistor Tr5. The transistor Tr5 has an emitter connected, via a diode D4, to the power source. The transistor Tr5 has a collector directly connected to the base. In other words, base and collector terminals of the transistor Tr5 are short-circuited. Accordingly, two transistors Tr5 and Tr9 cooperatively constitute a current mirror circuit.

An NPN transistor Tr6 has a collector connected to the collector of the transistor Tr4. An NPN transistor Tr7 has a collector connected to the collector of the transistor Tr5. A capacitor C2 has one end connected to the collector of the transistor Tr4 and the other end connected to the collector of the transistor Tr5. The transistors Tr6 and Tr7 have emitters commonly connected to a collector of an NPN transistor Tr3. The transistor Tr3 has an emitter connected, via a constant-current circuit CC1, to the ground.

Accordingly, the transistors Tr6, Tr7, Tr4, and Tr5, the capacitor C2, and the diodes D3 and D4 constitute a differential amplifier 2.

The transistor Tr6 has a base connected to a reference voltage terminal that maintains an electrical potential of Vref. The transistor Tr7 has a base connected, via a backup amplifier, to the other end of the capacitor C1. Thus, as negative feedback, the base of the transistor Tr7 receives base current of the transistor Tr1. The transistor Tr3 has a base receiving a predetermined pulse signal.

According to the above-described circuit arrangement, the transistors Tr6 and Tr7 perform a differential operation in response to an audio signal entered to the base of the transistor Tr7. Thus, the circuit generates differential output current corresponding to the transistors Tr4 and Tr5.

Current flowing through the transistor Tr5 is equal to current flowing through the transistor Tr9, current flowing through the transistor Tr10, current flowing through the transistor Tr11, and current flowing through the transistor Tr2. On the other hand, current flowing through the transistor Tr4 is equal to current flowing through the transistor Tr8 and current flowing through transistor Tr1.

In the above-described embodiment, the transistor Tr1 is a PNP transistor and the transistor Tr2 is an NPN transistor. The transistor Tr1 and the transistor Tr2 have base terminals commonly connected. If current Ic flows through the transistors Tr6 and Tr5, the same current Ic flows through the transistors Tr1 and Tr2. In this case, base current Ic/β flowing from emitter to base terminals of the transistor Tr1 is equal to base current Ic/β flowing from base to emitter terminals of the transistor Tr2.

More specifically, as a negative feedback output, the differential amplifier 2 generates a very small output equivalent to 1/β of the current Ic flowing through the transistors Tr6 and Tr7. In this case, β is a gain of the transistors Tr1 and Tr2, which is set, for example, to 100.

In this manner, the differential amplifier 2 equalizes the voltage of point A (i.e., base voltage of the transistor Tr7) with Vref (i.e., voltage value supplied to the base of the transistor Tr6) The output current becomes a 1/β level. An amplifier including the differential amplifier 2 connected to the point A (i.e., the other end of the capacitor C1) has a very small “gm.” As the amplifier functions as a resistor circuit having a resistance value of 1/gm, it can be regarded as having a large resistor connected to the point “A.”

A gate capacitance of the MOS transistor M1 influences the electrical potential of the point A. However, regardless of such influences, the impedance at the point A remains at a higher level. Accordingly, even if the capacitance of the capacitor C1 is relatively small, the embodiment can provide a high-pass filter having a low cut-off frequency fc. Formula fc=½πRC defines the cut-off frequency fc.

According to the embodiment, the differential amplifier 2 turns on or off in response to a pulse signal entered to the base of the transistor Tr3. Accordingly, the embodiment can reduce the current flowing through the differential amplifier 2. For example, if a duty ratio of the pulse signal is 1%, the current value decreases to 1/100.

If the constant-current circuit CC1 supplies operating current of I1=20 μA, current flowing through the transistors Tr6 and Tr7 has a half value of I1 (=10 μA). The base current of the transistors Tr1 and Tr2 is approximately 100 nA (=10 μA/100 when β=100). If a change in base voltage of the transistors Tr6 and Tr7 (i.e., a change width in the input signal) is approximately 1V, current of 100 nA flows in the circuit in response to the voltage change of 1V. In other words, the circuit has a resistance value of 10 MΩ. Furthermore, if the duty ratio of the pulse signal entered to the transistor Tr3 is approximately 10%, the resistor circuit has a resistance value of 100 MΩ. If the capacitance of the capacitor C1 is 100 pF, the filter has a cut-off frequency of approximately 16 Hz.

Although the differential amplifier 2 performs a pulsative operation, a negative feedback path for the differential amplifier 2 includes the backup amplifier. The backup amplifier can eliminate drawbacks caused by the pulsative operation of the differential amplifier 2. According to an embodiment, a transistor provided at an input terminal of the backup amplifier is a MOS transistor. The MOS transistor does not generate base current and therefore does not adversely influence the base current of the transistor Tr1.

Moreover, according to the above-described embodiment, respective diodes D1 to D4 are in the current path connected to the power source. The diode causes a substantially constant voltage drop. If the current value is small, the voltage drop at a diode becomes a relatively large value. Thus, the diode can serve as a large resistor. Accordingly, the time constant of respective diodes, transistors and the capacitor C2 becomes larger. The resistor circuit has a resistance value.

What is claimed is:

1. A high-pass filter comprising:
a capacitor having one end receiving an input signal and the other end outputting an output signal, and
a resistor circuit connected between a power source and the other end of the capacitor,
wherein the resistor circuit comprises:
a PNP transistor having a base connected to the other end of the capacitor,
an NPN transistor having a base connected to the other end of the capacitor, and
a differential amplifier supplying complementary current to the PNP transistor and the NPN transistor,
wherein the differential amplifier receives, as negative feedback, the output signal from the other end of the differential amplifier.

2. The high-pass filter according to claim 1, wherein the differential amplifier includes a pair of differential transistors connected to a pair of transistors on input sides of current mirror circuits, so that currents flowing through respective input-side transistors flow into the pair of differential transistors,
wherein a pair of transistors is provided on output sides of the current mirror circuits, so that output-side transistors and the input-side transistors are current-mirror corrected, and
currents flowing through the output-side transistors are supplied to the PNP transistor and the NPN transistor, respectively.

3. The high-pass filter according to claim 1, wherein the differential amplifier includes a constant current source that supplies operating current, and the constant current source is a pulse-driven type.

4. The high-pass filter according to claim 2, wherein the differential amplifier includes a constant current source that supplies operating current, and the constant current source is a pulse-driven type.
